(19) United States
(12) Patent Application Publication
(10) Pub. No.: US 2005/0060353 A1
(43) Pub. Date: Mar. 17, 2005

(54) Method and system for personalized information management

(76) Inventors: Ah Hwee Tan, Singapore (SG); Hwee Leng Ong, Singapore (SG); Suat Ling Jamie Ng, Singapore (SG); Hong Pan, Singapore (SG)

Correspondence Address: OSTROLENK FABER GERB & SOFFEN, 1180 AVENUE OF THE AMERICAS, NEW YORK, NY, 100368403, US

(21) Appl. No.: 10/489,925

(22) PCT Filed: Sep. 14, 2001
(86) PCT No.: PCT/SG01/00189

(51) Int. Cl. G06F 17/30

(52) U.S. Cl. 707/200

(57) ABSTRACT

A method and system for gathering, organizing, analyzing, tracking, and publishing of information through person-alizable information portfolios, the personalized information management system comprising an information gathering module for retrieving relevant information from internet and/or intranet sources, a personalized content management module for manipulating and annotating portfolio, a content mining module for analyzing portfolio, a content publishing module for publishing and sharing of portfolio, a user interface module for supporting the various modules, and an account management module for managing user access and directory maintenance.

### FIELD OF THE INVENTION

This invention relates to pattern processing and information management and more specifically to a method and system for gathering, organizing, and tracking information. Related fields of invention include information organization, knowledge management, and content personalization.

### BACKGROUND OF THE INVENTION

Advances in digitization and the popularization of the World Wide Web have made a huge amount of digital information readily available. However this information is of no use if it cannot be retrieved, organized, and tracked properly when needed.

Currently, publicly accessible search engines such as Yahoo!, Excite, Alta Vista, Lycos, etc. can retrieve information in response to a users' search queries but do not organize the search results. Those that organize results into folders to facilitate navigation and browsing, such as Copernics, BullsEye, and NorthernLight, etc., do not support manipulation and personalization of folders. Often, one has to use a web browser to collect the information and manually organize the results into a separate information portfolio according to the user's needs and preferences. The process is tedious and time consuming because information portfolios need to be constantly updated to keep the content up-to-date. Certain Internet portals, such as “My Yahoo!” offer personalized content delivery services that allow users to define profiles and automatically forward news or alerts based on the user's profile through email. However, such services do not help users to maintain information on specific topics.

Competitive intelligence tools, such as WinCite, Correlate, and STRATEGY! etc., provide means for users to define their business landscapes for gathering and tracking relevant information. Again, they don't provide an environment for organizing and managing domain information and knowledge. Knowledge management tools, such as Knowledge Server, Knowledge Organizer, and iMiner for Text, etc., provide facilities for organizing and analyzing text-based information; none of them, however, provides the personalization capability needed to build and maintain a personal information portfolio tailored to individual needs and preferences.

Further prior art on information management is described herein. U.S. Pat. No. 6,078,924 describes an information platform that gathers, organizes, and analyzes information. U.S. Pat. No. 6,009,442 describes a method to import, index, categorize, store, search, retrieve, manipulate and archive electronic documents. U.S. Pat. No.6,078,913 describes organizing documents in clusters, and providing facilities to update new documents while maintaining a clusters database. U.S. Pat. No. 6,078,913 describes a means for collecting information and for organizing and updating collected information. U.S. Pat. No. 5,974,412 describes a means for collecting and organizing information for the purpose of categorizing users. U.S. Pat. No. 5,933,827 describes a means for identifying new web pages of interest. None of the systems described in the above patents provide a flexible method for manipulating information structure for creating personalized information portfolios. In addition, none of them provides a solution for supporting the building, maintenance, analyzing, and publishing of information portfolios. Each of the preceding patents is hereby incorporated by reference in its entirety.

### SUMMARY OF THE INVENTION

The present invention provides a method and system for personalized information management. The disclosed method comprises building a portfolio containing information relevant to a topic based upon a user's search query, manipulating the portfolio according to the user's interests and preferences in terms of content and organization, and using the portfolio as a basis for retrieval and organization of new information.

The personalized information management system comprises an information gathering module for retrieving relevant information from internet and/or intranet sources, a content management module for organizing information into portfolios and personalizing portfolios, a content mining module for analyzing portfolios, a content publishing module for publishing and sharing of portfolios, an account management module for handling user access and directory management, and a user interface module for graphical visualization and for obtaining a users' input.

The invention has a number of advantages over the prior art: The invention allows users to build information portfolios by gathering and organizing on-line information according to his/her needs and preferences. The users can annotate the retrieved information and personalize the portfolios in terms of the content and how the content is organized (i.e. the information structure). In addition, new knowledge or meta information can be derived from the raw information content in the portfolio through various data analysis methods. The personalized portfolios can be constantly updated by tracking relevant information, and new information can be organized into appropriate folders within the portfolios automatically. The portfolios thus function as “living reports” that can be published and shared by other users. In all, the invention provides an environment for gathering, organizing, tracking, analyzing, and publishing information and know-how about specific topics of interests.

### BRIEF DESCRIPTION OF THE DRAWINGS

Embodiments of the invention will now be described by way of examples with reference to the accompanying drawings in which:

FIG. 1 illustrates an embodiment of a personalized information management system according to the present invention.

FIG. 2 shows a sample login screen for the personalized information management system.

FIG. 3 shows an exemplary screen shot illustrating a user's portfolios.

FIG. 4 shows an exemplary screen shot illustrating a template of predefined folders.

FIG. 5 shows an exemplary screen shot illustrating the interactions between the information gathering module with the content management module.

FIG. 6 shows an exemplary screen shot illustrating search results in the default graphical display.

FIG. 7 shows an exemplary screen shot illustrating “by section-clusters” display for search results in FIG. 7.

FIG. 8 shows an exemplary screen shot illustrating “by clusters” display for search results in FIG. 7.,

FIG. 9 shows an exemplary screen shot illustrating saving search, results into a portfolio.

FIG. 10 shows an exemplary screen shot illustrating new documents/sites found by crawlers highlighted in a different colour.

FIG. 11 shows an exemplary screen shot illustrating creation of new portfolio dialog.

FIG. 12 shows an exemplary screen shot illustrating view of portfolio created.

FIG. 13 shows an exemplary screen shot illustrating editing cluster properties.

FIG. 14 shows an exemplary screen shot illustrating deletion of selected cluster.

FIG. 15 shows an exemplary screen shot illustrating grouping of clusters.

FIG. 16 shows an exemplary screen shot illustrating adding of new items to a cluster.

FIG. 17 shows an exemplary screen shot illustrating public view of all shared clusters.

FIG. 18 shows an exemplary screen shot illustrating view of a selected public portfolio.

FIG. 19 shows an exemplary screen shot illustrating identification of hot topics and tracking of news.

FIG. 20 shows an exemplary screen shot illustrating visualization of clusters and spotting new topics or popular topics.

FIG. 21 shows a flowchart of a typical user session to create a portfolio according to a preferred embodiment of the present invention.

FIG. 22 shows a flowchart of the steps to load a previously saved user portfolio for editing according to a preferred embodiment of the present invention.

FIG. 23 shows a flowchart of the steps to load a shared or public portfolio according to a preferred embodiment of the present invention.

### DETAILED DESCRIPTION OF THE INVENTION

Referring to FIG. 1, there is provided an information management system 10 comprising a content gathering module 20, a content management module 30, a content mining module 40, a content publishing module 50, a document database 60, a portfolio knowledge base 70, a domain-specific thesaurus 72, a user interface module 80, an account management module 90, and an audit module 92.

The information gathering module 20 searches and collects information from Internet and intranet sources in response to users' search queries and spools them in the document database 60. The content management module 30 organizes the gathered resources into information portfolios according to each user's needs and preferences. These portfolios, stored in the portfolio knowledge base 70, can be subsequently retrieved for publishing or sharing via the content publishing module 50. In addition, the content mining module 40 looks at the contents of these portfolios to highlight and discover new or implicit information based on the information present in the portfolio according to the users' objectives. Use of a thesaurus 72 may be incorporated to help in the organizing and mining process. The document database 60, portfolio knowledge base 70 and thesaurus 72 may be stored in any conventional recordable storage format, for example a file in a storage device, such as magnetic or optical storage media, or in a storage area of a computer system.

The user interacts with the various modules through a user interface module 80 that may comprise a graphical user interface, keyboard, keypad, mouse, voice command recognition system, or any combination thereof, and may permit graphical visualization of information portfolios. The supporting account management module 90 takes care of user accounts, access rights and their directories maintenance. In addition, there is provided an audit module 92 at the backend to keep track of information like user access and portfolio usage statistics etc. Various-modules are described herein with more details and examples.

Account Management Module

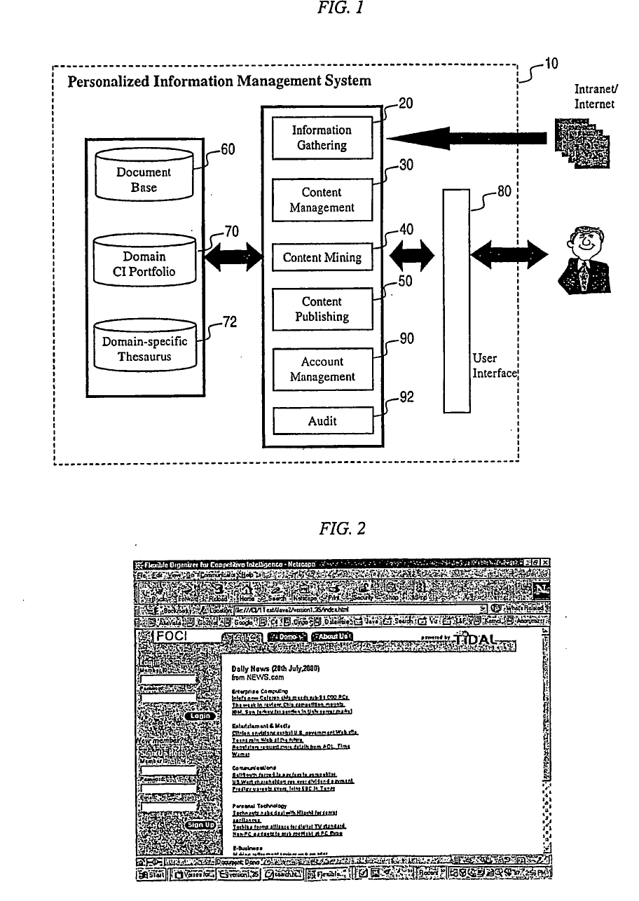

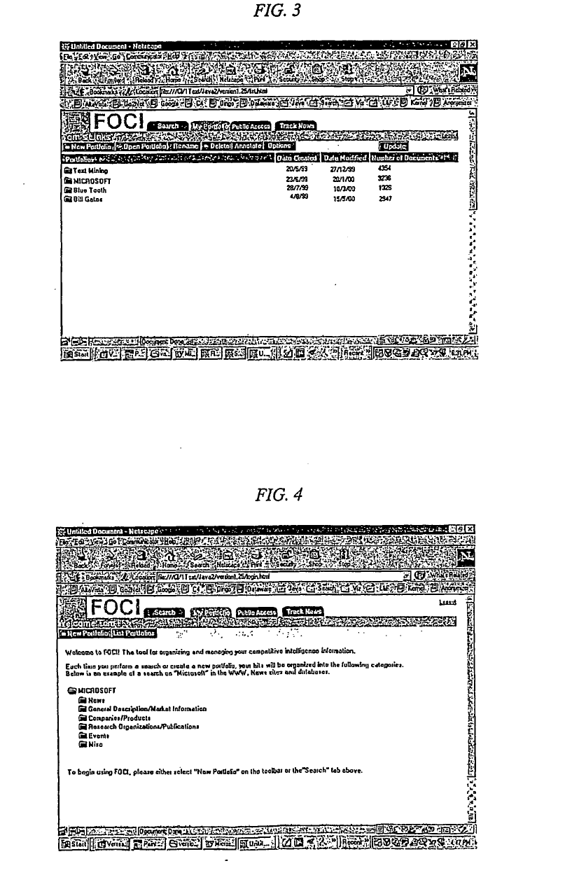

The account management module 90 takes care of all access by multiple and/or concurrent users. It maintains a database of registered users and their access rights to the public or private portfolios. FIG. 2 shows a sample login screen for this application. FIG. 3 shows what happens when an existing user logs in to the system. A list of user portfolios that has been created by the user will be displayed. In this case, the user has created four different portfolios. FIG. 4 shows what happens when a new user logs-in to the system. It informs the user that a portfolio may be created by using the default template. The user can initiate a search from here to start his information gathering by clicking on the Search tab.

Information Gathering Module

The information gathering module 20 comprises various means for collecting relevant sources from the world wide web or other distributed network. This can be achieved through
a) on-line search via various major search engines or customized search engines;
b) use of background directed crawlers; and
c) specifying user defined URLs.

FIG. 5 shows the interaction of the information gathering module 20 with the content management module 30, the account management module 90, and the user interface module 80. After a user logs-in to the server and performs a search, the search results will be stored in the document database 60 that can be used by the content management module 30 for indexing or feature selection before organizing into portfolios. There are provided predefined portfolio templates (consisting of predefined sets of folders that are appropriate for specific domains) that may be used by the user. User-defined URLs are specified through the user interface module 80 where the user may decide which category/cluster to add this URL to.

The user can set the crawler to capture new documents that fit into the portfolio template captured by the user on a regular basis. There are 3 types of crawlers:
Web-crawler
News-crawler
Database crawler
   They differ in the source in which they obtain the search results, that is, from other search engines, news content providers and databases respectively.

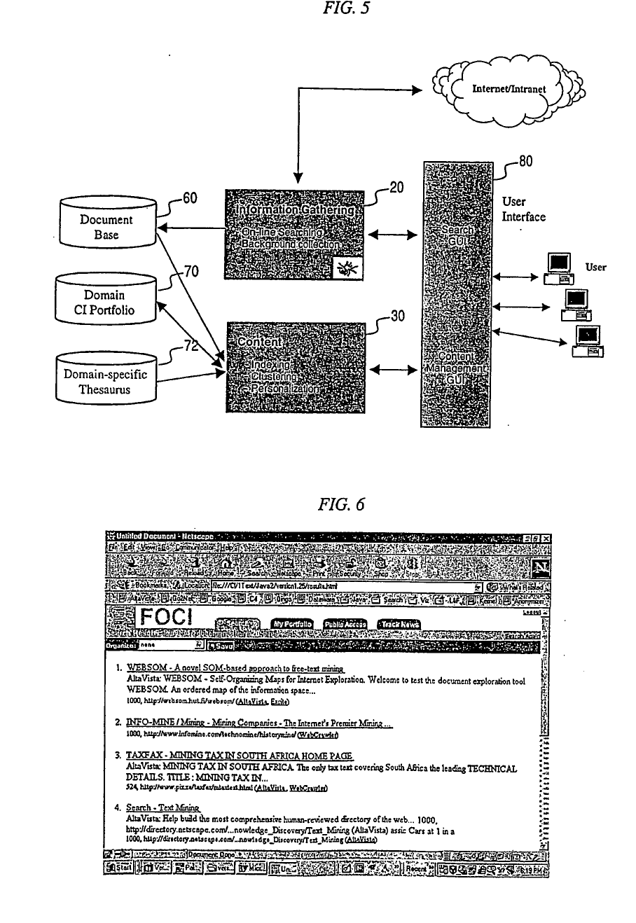

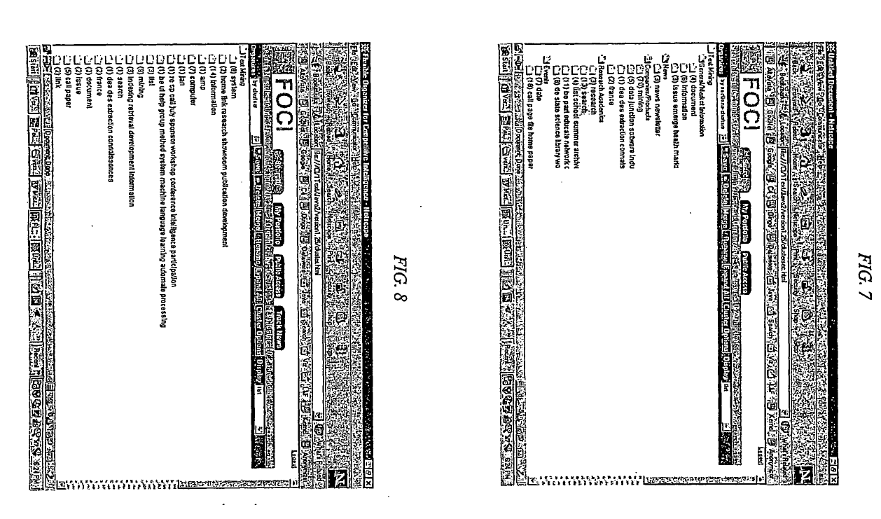

FIG. 6 shows a sample search results received after a search on the phrase “Text Mining”. This result can be displayed according to the previously mentioned predefined template as shown in FIG. 7. Alternatively, it may be viewed as just clusters from which the user can create his/her own template (FIG. 8).

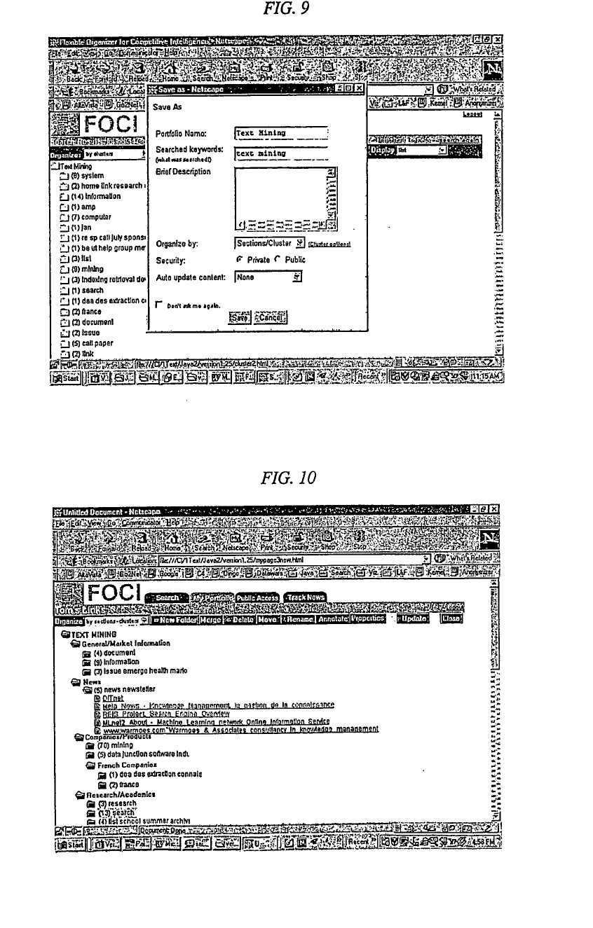

Search results may be saved into a portfolio template as shown in FIG. 9. The user can specify how frequently this portfolio is to be automatically updated (e.g. daily, weekly, bi-weekly, monthly, bimonthly or quarterly) by the crawlers at the Auto Update content field. When the portfolio is opened after the update, the new documents returned by the crawlers will be displayed as highlighted within the portfolio. (See FIG. 10.)

Personalized Content Management Module

The content management module 30 performs creation and manipulation of information portfolios. An information portfolio typically consists of a hierarchy of clusters. It may comprise a combination of predefined and user-defined folders; each may in turn comprises sub-folders containing documents or information elements. An example of a predefined section template for the Information Technology domain may be as follows:
News
Market Information
Companies/Products
Research/Organization
Events
Miscellaneous

Associated with each object, including portfolios, folders, sub-folders, and documents is a set of properties comprising labels and annotations. The content management module 30 provides the following main functions:
Grouping documents according to predefined template sections;
Unsupervised clustering (includes indexing/feature selection)—that is, to group similar documents together automatically;
Summary of clusters;
User annotation;
Deletion of documents from folders;
Moving of documents across folders;
Adding of new information/documents; and
Creation, loading, and saving of personalized portfolio.

In addition, the folder personalization features supported include:
Tuning the coarseness and criteria of clustering software
Labeling of folders
Creation of new folders
Merging of folders by grouping them together under a new name
Splitting of a folder by moving documents under different group name.

The unsupervised clustering with folder personalization features can be provided by the user-configurable clustering method as disclosed in Singapore Patent application No. 2000 03177-3 and U.S. patent application Ser. No. 09/875,271, filed Jun. 7, 2001, the entire disclosure of which is hereby incorporated by reference, entitled “Method and system for user-configurable clustering of information”. User-configurable clustering allows one to incorporate his/her preferences into an information clustering system. A user-configurable information clustering system comprises an information clustering engine for clustering of information based on similarities, a user interface module for displaying the information groupings and obtaining user preferences, a personalization module for defining, labeling, modifying, storing and retrieving cluster structure, and a knowledge base where a user-defined cluster structure is stored. In essence, this system allows a user to create a cluster structure and influence or personalize the cluster structure by indicating his or her own preferences as to how information should be grouped. This system further allows the user to store the cluster structure and subsequently retrieve it for future use.

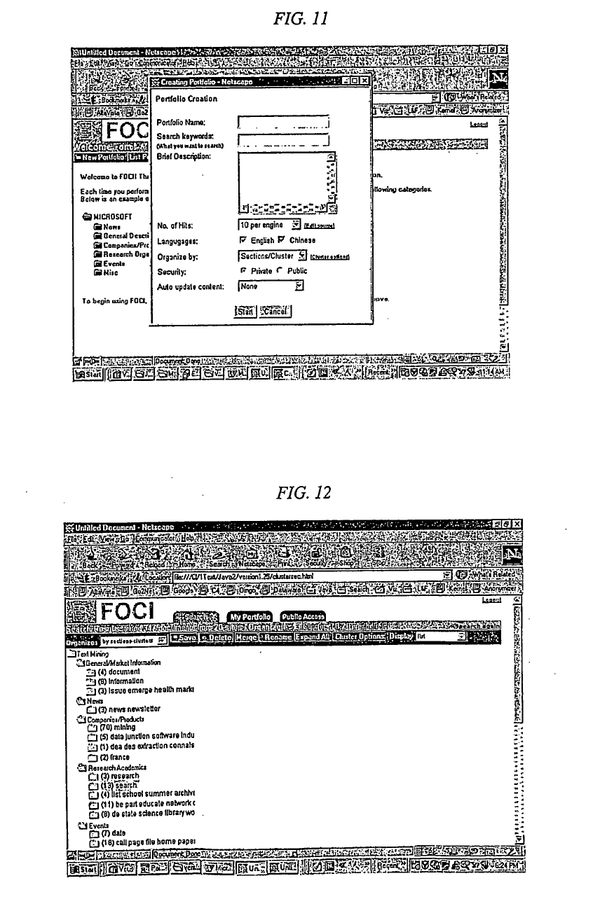

The user can create a portfolio by conducting a search and saving the results into a template as described in FIGS; 6-9 or simply by selecting New Portfolio from FIG. 4. A “Create Portfolio” dialog appears as shown in FIG. 11. Here, the user specifies the name of the portfolio, the keywords to be fed to the search engine, search parameters, (e.g., number of hits and language to search for), how the result is to be viewed (e.g. by Sections/Cluster), whether this portfolio will be private or whether it can be viewed by other users of the system, and how often the portfolio should be updated. Once the “Start” option is selected, the system performs the search and, as shown in FIG. 12, automatically organizes the results into the predefined template and groups the documents within each pre-defined section.

At this point, the user can perform editing on the display, typically by means of a keyboard, mouse, or other input device connected to their computer. By clicking on “Properties”, the user can change the name of a cluster as well as provide some annotation about a cluster (FIG. 13). Alternatively, the user can rename any cluster by highlighting it and typing over the highlighted words.

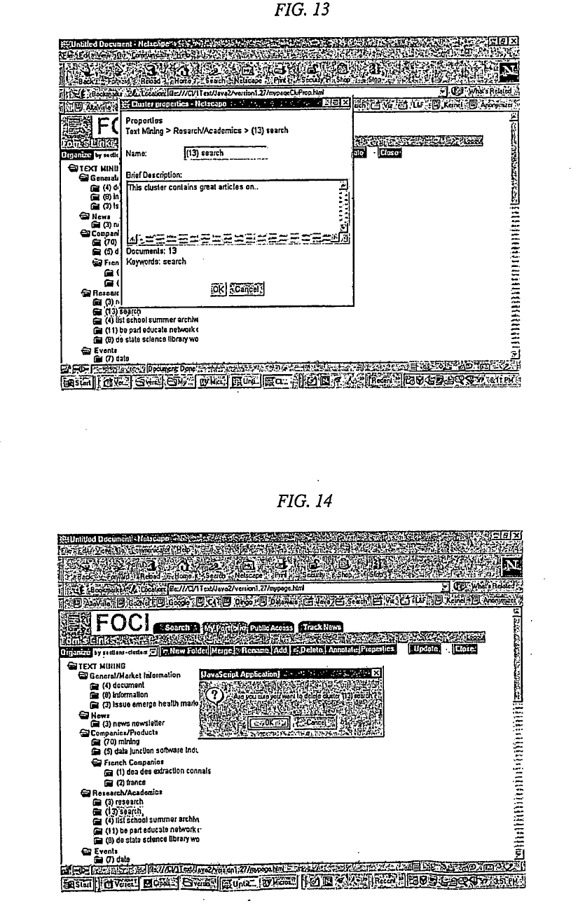

FIG. 14 shows the deletion of a selected cluster. A confirmation box pops up to confirm the deletion. Internally, the system marks the deleted cluster/document as irrelevant but it may be retrieved again should the user decide to undo his deletion.

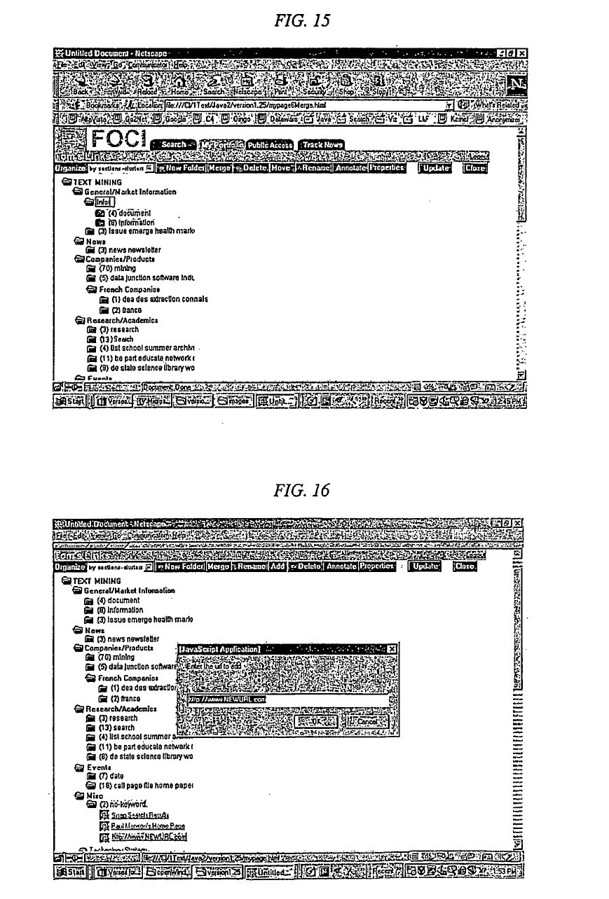

FIG. 15 shows how a new cluster has been created and two clusters merged under this new group. Referring to FIG. 16, a new web document can be added to an existing cluster by selecting the cluster and then choosing the Add menu.

Content Publishing Module

The content publishing module 50 provides the following functions:
Publishing the portfolio in a desired format (e.g. html); and
Sharing portfolios with other users

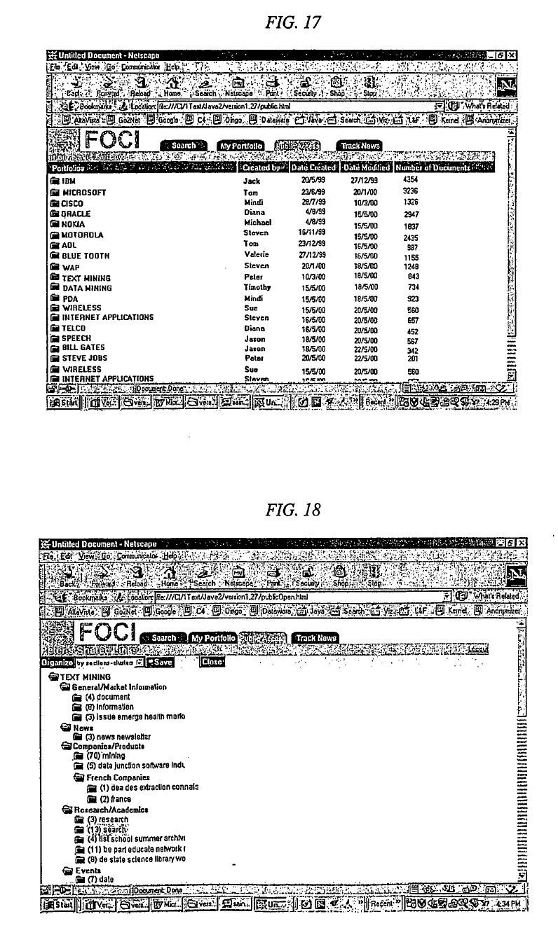

FIG. 17 shows a list of portfolios that are shared by the users. FIG. 18 shows a portfolio view when a public portfolio on FIG. 17 is selected. The user can “select all” under the Organize menu to show all the annotation of this particular portfolio as well as double click on any of the items under the clusters-to view the actual documents.

Content Mining Module

After the user has created the portfolio, he can mine the portfolio he has created by using various analysis techniques to derive knowledge or meta information from the raw information content in the portfolio. The content mining module 40 performs mining functions such as the following:
identifying information that is new to the portfolio and highlighting it by creating new clusters and/or alerting the user to newly collected documents;
identifying significant and/or emerging information events, for example, news, weather, entertainment information, etc., using trend analysis based on the occurrence frequency with respect to time of said information events; and
identifying hidden relationships among events of interest by statistically analyzing the frequency at which they co-occur.

Different visualization techniques, trend analysis algorithms, and association techniques may be employed to carry put content mining. The domain specific thesaurus 72, in this example, or terms related to the IT domain, can be used to help make the analysis more relevant to this domain.

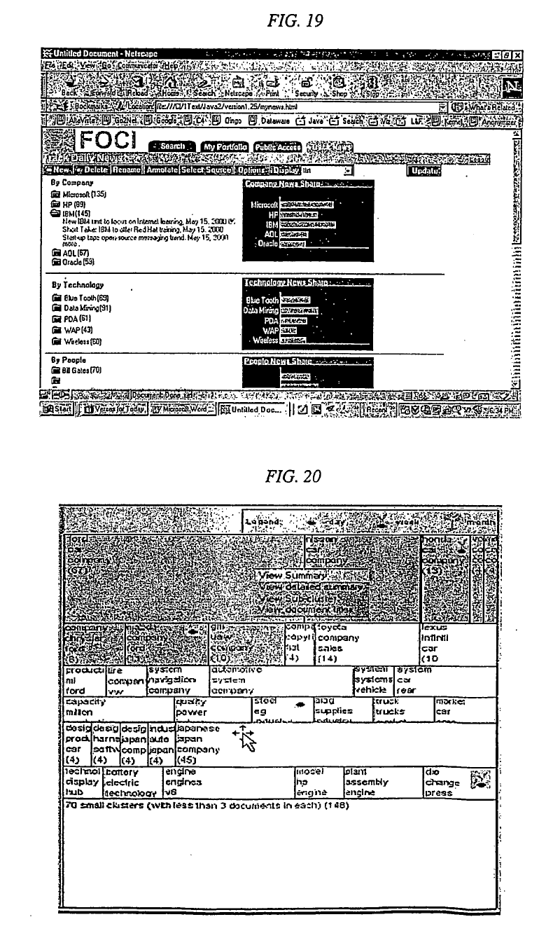

FIG. 19 shows a possible implementation of this module in the form of bar charts that depict the distribution of news by company or technology as a way of indicating how “hot” a particular company or technology is say, in the section on News. Alternatively, the display method entitled “A method of visualizing clusters of large collections of text documents” disclosed in international application PCT/SG00/002172, the entire disclosure of which is hereby incorporated by reference, can be used. This method allows a user to visualize clusters of large collections of text documents through use of a map facility which the user can employ to not only browse a text collection in an intuitive and meaningful manner but also to navigate and discover useful trends from the document collection. FIG. 20 shows an example of this visual map applied to the News section as an example. The size of the boxes indicates the cluster size. Keywords denoting the cluster are also shown within the cluster. Symbols appeared in some of the clusters indicate how new the cluster is, with respect to an initial news collection. In other words, a symbol associated with a cluster indicates whether the cluster is a day old (new topic) or a week old (topic has appeared for a while) or a month old (very old topic that is quite popular). Users can also set any cluster (that is, any rectangular area in this display) to be tracked so that any changes in the cluster will be highlighted in a colour of his choice.

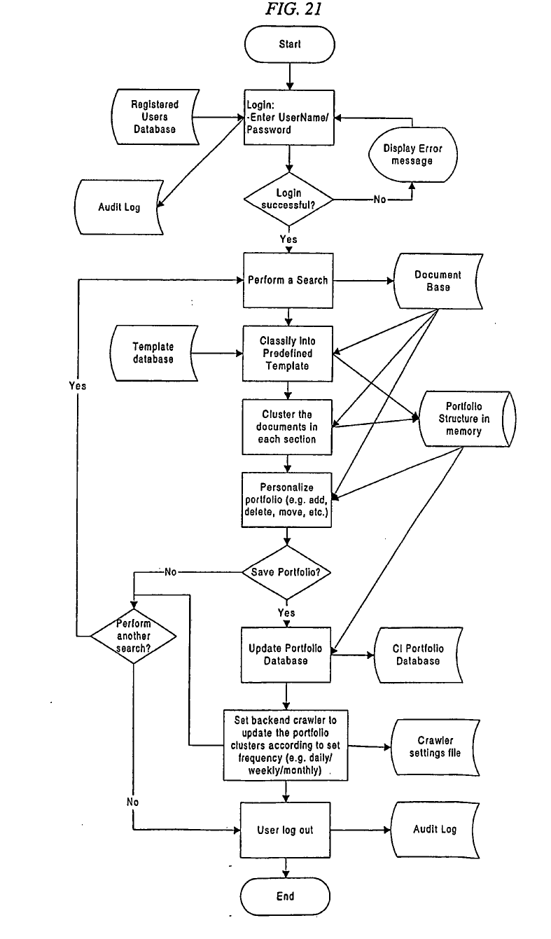

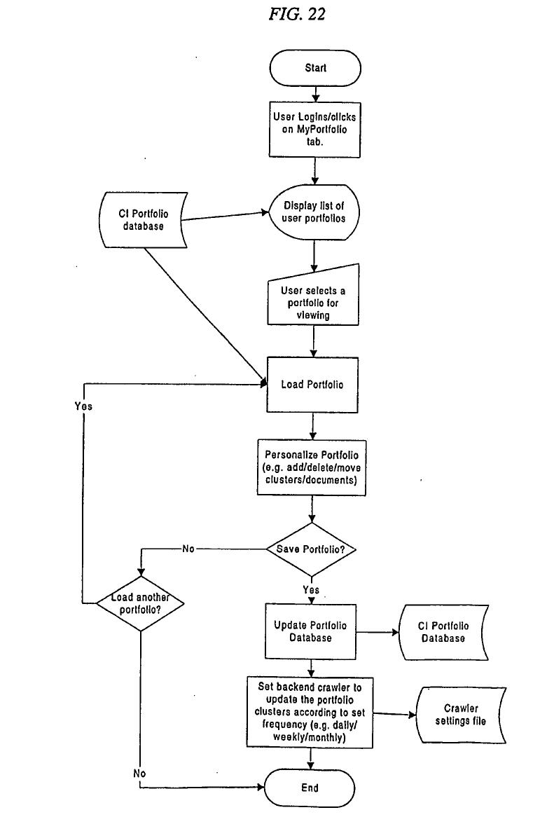

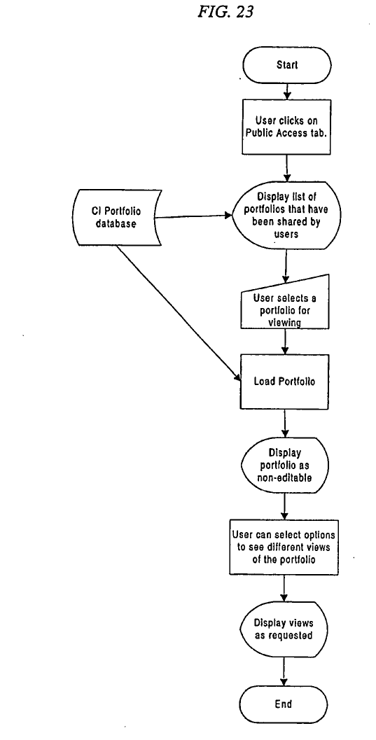

FIGS. 21 to 23 show the flowcharts of the portfolio management steps of a preferred embodiment of the above invention. FIG. 21 shows the flowchart of a typical user session to create a portfolio. FIG. 22 shows how a portfolio may be loaded for editing. FIG. 23 shows how a-user may view shared public portfolios.

The disclosed method can be executed using a computer system, such as a personal computer or the like, as is well known in the art. The disclosed system can be a stand-alone system, or it can be incorporated in a computer system, in which case the user interface can be the graphical or other user interface of the computer system, and the portfolio knowledge base can be, for example, a file in any of the computer system's storage areas, elements or devices. Moreover, while the system and method of the present invention have been illustrated for use with the internet and world wide web, the invention is equally suitable for use with any distributed network or even local area network which contains sources of data that may be searched and the results organized. One possible embodiment of the disclosed invention, closer to what has been described above, is a typical client-server implementation in which all processing and maintenance of the portfolios are carried out at a remote central server machine. A user can access the system and the portfolio by using a thin-client software, such as an internet browser.

Another embodiment is a fat-client implementation in which all processing and maintenance of the portfolios, less the content publishing, are done through software residing at the user's local machine. Users submit their portfolio to a central server through certain protocol, as is known in the art, to enable portfolio sharing.

Various preferred embodiments of the invention have now been described. While these embodiments have been set forth by way of example, various other embodiments and modifications will be apparent to those skilled in the art. Accordingly, it should be understood that the invention is not limited to such embodiments, but encompasses all that which is described in the following claims.

1. A method for personalized information management comprising:
a) gathering information from sources connected to a distributed network;
b) organizing said retrieved information into at least one information portfolio; and
c) personalizing said at least one information portfolio to conform to predefined user specifications.

2. The method according to claim 1 wherein said distributed network is selected from the internet, an intranet, and a local area network, wherein said distributed network includes at least one searchable source of information.

3. The method according to claim 2 wherein said gathering further comprises tracking of said information sources to update said portfolio at a user-specified interval.

4. The method according to claim 1 wherein said information portfolio comprises a hierarchy of at least one folder, at least one sub-folder, and at least one document.

5. The method according to claim 1 wherein said organizing comprises clustering of information into folders based on similarity of attributes of the data contained therein.

6. The method according to claim 1 wherein said organizing comprises
a) classifying information into a predefined set of folders; and
b) clustering of information into sub-folders based on similarity of attributes of the data within said predefined folders.

7. The method according to claim 5 wherein said organizing further comprises automatically generating information summaries within individual folders.

8. The method according to claim 1 wherein said personalizing comprises
a) annotating said at least one portfolio; and
b) saving said at least one portfolio onto a computer readable medium.

9. The method according to claim 8 wherein said personalizing further comprises at least one of:
a) adding at least one new folder to the said portfolio;
b) deleting at least one folder from the said portfolio;
c) grouping at least two folders together under a group label;
d) splitting at least one folder into at least two folders by selecting documents stored therein having dissimilar data attributes;
e) adding at least one document to a folder;
f) deleting at least one document from a folder; and
g) moving at least one document from a first folder to a second folder.

10. The method according to claim 1 further comprising analyzing said information portfolio to derive knowledge or meta information from raw information content.

11. The method according to claim 10 wherein said analyzing comprises at least one of the following:
a) identifying information that is new to said information portfolio;
b) analyzing said raw information content for the occurrence frequency of information events; and
c) analyzing said raw information content for the co-occurrence frequency of two or more information events.

12. The method according to claim 1 further comprising maintaining individual user information portfolios and publishing said portfolios for sharing between users.

13. The method according to claim 12 wherein said publishing comprises transforming the format of said portfolios for publishing.

14. The method according to claim 12 further comprising tracking user access and portfolio usage statistics.

15. The method according to claim 14 further comprising employing a user interface to support said gathering, organizing, personalizing, tracking, analyzing, publishing, account management, and audit processes.

16. An apparatus for personalized information management comprising
a) an information gathering module configured to search and integrate information from diverse sources; and
b) a personalized content management module configured to organize said information into portfolios and manipulate said portfolios.

17. The system according to claim 16 wherein said information gathering module is configured to search information sources on a distributed network according to user-specified search strings.

18. The system according to claim 17 wherein said information gathering module is further configured to track said information sources on said distributed network to update said information portfolios at user-specified intervals.

19. The system according to claim 16 wherein said information portfolio comprises at least one folder, each folder containing related information.

20. The system according to claim 16 wherein said personalized content management module clusters information into folders based on data having similar attributes.

21. The system according to claim 16 wherein said personalized content management module classifies information into a predefined set of folders; and clusters information into sub-folders based on the similarities of said data within said predefined folders.

22. The system according to claim 20 wherein said personalized content management module automatically generates a summary of information within folders.

23. The system according to claim 21 wherein said personalized content management module is further configured to
a) annotate any of the elements in the said portfolio and organize said elements into a hierarchy; and
b) save said portfolios onto a computer readable medium.

24. The system according to claim 23 wherein said personalized content management module further comprises at least one of:
a) means for adding at least one new folder to said portfolio;
b) means for deleting at least one folder from said portfolio;
c) means for grouping at least two folders under a group label;
d) means for splitting a folder into at least two folders by selecting documents having different data attributes;
e) means for adding at least one document to a folder;
f) means for deleting at least one document from a folder; and
g) means for moving at least one document from a first folder to a second folder.

25. The system according to claim 16 further comprising a content mining module for analyzing said portfolios to derive new knowledge or meta information from raw information content.

26. The system according to claim 25 wherein said content mining module comprises at least one of
a) means for highlighting at least one new topic;
b) means for discovering trends by identifying hot/major topics and emerging topics based on their occurrence frequencies with respect to time; and
c) means for analyzing said at least two topics to discover hidden relationships based on their co-occurrence frequencies.

27. The system according to claim 25 further comprising means for maintaining user information portfolios and means for publishing said portfolios for sharing between users.

28. The system according to claim 27 wherein said means for publishing comprises means for transforming the format of said information portfolio prior to publishing said information portfolio.

29. The system according to claim 27 further comprising an audit module to track of user access and portfolio usage statistics.

30. The method according to claim 29 further comprising a user interface front end module for supporting said information gathering, personalized content management, content mining, content publishing, account management, and audit modules.
